(19) United States
(12) Patent Application Publication
(10) Pub. No.: US 2007/0110885 A1
(43) Pub. Date: May 17, 2007

(54) Method for controlling retention of an organic compound or of a plurality of organic compounds inside a liquid or solid phase and applications of said method, in particular in the agri-food domain

(76) Inventors: Charles Divies, Dijon (FR); Gilles Feron, Lamarche Sur Saone (FR); Elisabeth Guichard, Reneve (FR); Isabelle Marie-Christine Andriot, Dijon (FR); Remy Cachon, Dijon (FR)

Correspondence Address: JACOBSON HOLMAN PLLC, 400 SEVENTH STREET N.W., SUITE 600, WASHINGTON, DC, 20004, US

(21) Appl. No.: 10/537,665

(22) PCT Filed: Dec. 5, 2003
(86) PCT No.: PCT/FR03/50155

§ 371 Date: May 31, 2006

(30) Foreign Application Priority Data
Dec. 6, 2002 (FR) 02/15488

(51) Int. Cl. A21D 2/16

(52) U.S. Cl. 426/654

(57) ABSTRACT

The invention relates to a method for checking the retention of an organic compound (i) or a plurality of organic compounds (i) within a liquid or solid phase, characterized in that it comprises a step in which the oxidoreduction potential of said solid or liquid phase is modified by contacting said solid or liquid phase with an oxidizing agent, a reducing agent or a neutral agent, the oxidoreduction potential value of said solid or liquid phase determining the retention degree of the organic compound (i) or each of the organic compounds (i) within said liquid or solid phase.

The present invention relates to a method for checking the retention of an organic compound or a mixture of organic compounds of interest within a liquid or solid phase as well as various applications thereof, including in food processing field, and more specifically for checking aromatic or organoleptic properties of compositions, in particular liquid ones, for use in human food or animal feed.

The capacity of checking the retention of an organic compound or a mixture of organic compounds of interest within a liquid or solid phase has a great interest in various industrial fields.

In food processing field, numerous tests have shown that the aroma perception changes considerably according to the composition and physico-chemical characteristics of the medium. It is particularly the case for low-fat or sweetener-based products, which present, after several weeks or months of storage, aromatic profiles very different from the finished product flavouring profile before its conditioning. After several weeks of storage under normally adapted conditions, such low-fat products may also present undesirable odours. To maintain the flavouring quality of such products, the manufacturers empirically modify the qualitative and quantitative aroma composition.

Various taste preservation and stabilization techniques for foodstuffs and beverages are known. French Patent Application published under number FR 2,032,637 describes such a technique, specifically applied to wine preservation. According to this technique, the taste of the foodstuff to be treated is stabilized by bringing such foodstuff in contact with a “redox potential stabilizer”, which can be oxygen, hydrogen, a metal or even ion exchange resins. As a “redox potential stabilizer”, the examples of the patent exclusively disclose the use of metals, ion exchange media or activated carbons.

This document teaches that there is a correlation between the redox potential of some food products and the development of undesirable chemical reactions in said food product.

However, in Patent FR 2,032,637 the possible existence of a correlation between volatility and/or retention of the aroma(s) contained in the food products and the redox potential of the product is neither established nor suggested.

Thus, there is a need in food processing industry to hold substantially constant the organoleptic or aromatic properties of the food compositions during their storage preceding their consumption. In particular, holding the food composition organoleptic or aromatic properties with time is conditioned, at least in part, by the aroma retention within said composition.

In other technical fields, it would be advantageous to be able to check the retention of an organic compound within a liquid or solid phase. It is for example the case for molecule separation methods, in particular molecule extraction methods from a starting product, wherein it is attempted to selectively transfer the molecule(s) to be extracted, of the starting product constituting a first phase, to an extraction solvent constituting a second phase.

The needs as defined above are now achieved according to the invention.

It has been shown according to the invention that the retention degree of a given organic compound (i) within a liquid or solid phase could be checked by modifying the oxidoreduction potential of said liquid or solid phase containing the organic compound (i) of interest.

It has therefore been shown according to the invention that the value of the oxidoreduction potential of a composition containing an organic compound (i) of interest allows, according to the value of the retained oxidoreduction value, to cause the release of the organic compound (i) from the liquid or solid phase and thus to reduce the content of said organic compound within said composition, or in contrast to cause the retention of said organic compound within said composition.

Still more specifically, it is shown that an organic aroma-type compound of interest, initially contained in a liquid phase, the interface of which is in contact with a gas phase, can be partially transferred from the liquid phase to the gas phase, or inversely retained within the liquid phase, according to the modification made to the redox potential value of said liquid phase.

Thus, it is shown according to the invention that the oxidoreduction potential value of a given liquid or solid phase containing an organic compound (i), determines the retention degree of said organic compound (i) in this liquid or solid phase.

When the liquid or solid phase contains a plurality of organic compounds (i), the oxidoreduction potential value of said phase determines the retention degree of respectively each one of the organic compounds (i) in such phase.

In particular, when the liquid or solid phase consists of a human food or animal feed composition comprising a plurality or a mixture of organic compounds (i), more specifically aroma-type organic compounds, the oxidoreduction potential value applied to this first phase causes the retention of the plurality of organic compounds in such first phase, or inversely the release of the plurality of organic compounds (i) from this liquid or solid phase and their transfer from said phase to a second phase of a distinct type from the first phase.

In other cases, wherein the first phase is made of a complex mixture comprising a plurality of organic compounds (i), the setting of the redox potential of the complex mixture at a predetermined value causes (1) the retention of some organic compounds (i) within said first phase and (2) the release of some other organic compounds (i) from said liquid or solid phase, and their transfer from said first liquid or solid phase to a second phase of a distinct type from the first phase.

When the first liquid or solid phase comprises a complex mixture of a plurality of organic compounds, the retention or release effect for several organic compounds (i) of interest included in the mixture of organic compounds can be obtained by applying to such liquid or solid phase a predetermined redox potential value, the retention or the release of the other organic compounds also contained within said liquid or solid phase being of no importance.

For example, when the method of the invention is applied to a phase consisting of a liquid food product containing a complex mixture of organic aroma-type compounds, the organoleptic qualities aimed for said liquid food product can be obtained by setting the redox potential of said liquid product to a predetermined value for which only some flavouring organic compounds, i.e. the organic compounds of interest, are respectively retained or released from the first phase, it being understood that said flavouring organic compounds (i) of interest selectively retained or released from the liquid phase are those imparting to the liquid food product the organoleptic characteristics or properties that are aimed at.

According to the invention, the plurality of the organic compounds (i) included in a first phase which comprises a complex mixture of organic compounds, including said plurality of organic compounds (i), and which impart to said phase the desired properties, in particular the desired organoleptic properties when the organic compounds (i) are of an aroma type, are thus denoted, for purposes of the present description, by organic compounds (i) “of interest”.

By “organic compound (i) of interest”, it is meant, according to the invention, an organic compound of low molecular weight, i.e. having a molecular weight of less than 500. In most cases, an organic compound (i) of interest has a molecular weight of less than 400 and preferably less than 300. Due to its low molecular weight, an organic compound (i) of interest according to the invention is considered as “volatile”, i.e. it has the capacity to be transferred from a first phase to a second phase, at room temperature from 20° C. to 25° C. Preferably, an organic compound (i) of interest according to the invention belongs to the family of the aroma-type compounds that impart flavour, taste or sent characteristics or properties to the product. In particular, an organic compound (i) of interest belongs to the family of aromatic compounds employed in food processing industry or even in fragrance industry.

According to a first aspect, it is advantageous to apply to said liquid or solid phase a redox potential value such that the organic compound (i) or the plurality or the mixture of organic compounds (i) of interest are retained in said phase. Such an object is particularly desired when said phase consists of a hydrophilic liquid, a hydrophobic liquid or a solid food composition and that it is desired to hold constant, during storage or preservation, the initial organoleptic qualities of flavour, taste or sent in said food composition.

According to a second aspect, it advantageous to apply to said liquid or solid phase a redox potential value such that the organic compound (i) or the plurality or the mixture of organic compounds (i) of interest are released from this first liquid or solid phase and transferred into a second phase of a distinct type from this first phase. Such an object is aimed for, for example, when said first liquid or solid phase consists of a food composition extemporaneously prepared or that has to be consumed rapidly after its manufacturing, and when it is desired to cause the release in the atmosphere of the aromas that are likely to increase the appetence for the consumer. This aspect of the invention is also advantageous when the first phase consists of a liquid medium from which it is aimed to extract pollutant organic compounds (i).

According to a third aspect, it is advantageous to apply to the first liquid or solid phase a redox potential value such that some organic compounds (i) are released from the first phase whereas other organic compounds (i) being also initially contained in said first phase are retained therein.

An object of the invention is to check the retention of an organic compound (i) or a plurality of organic compounds (i) within a liquid or solid phase, characterized in that it comprises a step in which the oxidoreduction potential of said solid or liquid phase is modified by contacting said solid or liquid phase with an oxidizing agent, a reducing agent or a neutral agent, the oxidoreduction potential value of said solid or liquid phase determining the retention degree of the organic compound (i) or each of the organic compounds (i) within said liquid or solid phase.

The retention degree of the organic compound (i) or the plurality of organic compounds (i) can be determined by measuring the mass sharing coefficient (Ki) of the organic compound (i) or each of the organic compounds (i) between the liquid or solid phase, also referred to as first liquid or solid phase, and a second phase that can be liquid or gaseous.

For implementing the methods of the invention, the previous determination of the mass sharing coefficient Ki of an organic compound (i) of interest, between a first and a second phase, and for a series of redox potential values of the first phase, gives the man of the art the opportunity to determine in advance the redox potential to be applied to said first phase to achieve the desired retention degree of said organic compound (i) of interest in this first phase. The methods according to the invention make possible a rational checking of the retention degree of one or a plurality of organic compounds (i) of interest in said first phase. When this first phase consists of a food product, the methods of the invention allow consequently a rational checking, based on objective measurements, of the organoleptic qualities of such food product.

Another object of the invention is to provide a method for checking the mass sharing coefficient Ki of an organic compound (i) or of a plurality of organic compounds (i) between a first phase of a first given type and a second phase of a second given type, the first and the second phase having at least a common surface of contact, the first phase type being selected from a liquid phase and a solid phase and the second phase type being selected from a liquid phase and a gas phase, said method being characterized in that it comprises a step in which the oxidoreduction potential of at least the first phase is modified by contacting said first phase with an oxidizing agent, a reducing agent or a neutral agent, the oxidoreduction value of the first phase determining the value of the mass sharing coefficient Ki of the organic compound (i) or each of the organic compounds (i).

According to a particular aspect in the implementation of the above method, the invention provides as an object a method for checking organoleptic properties or characteristics of taste, flavour or sent in a product consisting of a first liquid or solid phase, said method being characterized in that it comprises a step in which the oxidoreduction potential is modified of at least said product constituting said first liquid or solid phase with an oxidizing agent, a reducing agent or a neutral agent until reaching a predetermined value of the oxidoreduction potential of said product constituting said first phase.

According to a first advantageous embodiment of the method, the oxidizing agent, the reducing agent or the neutral agent is respectively an oxidizing gas, a reducing gas or a neutral gas.

According to a second advantageous embodiment of the method, the oxidizing agent or the reducing agent is a respectively oxidizing or reducing organic or mineral compound.

The organic or mineral compound is provided in solid or liquid form according to the cases. In particular, the initially solid organic or mineral compound can be dissolved or slurried in a solution, in particular an aqueous or oily one before the use thereof as an oxidizing or reducing agent.

Preferably, the product constituting said first phase consists of a food processing product, which is advantageously under a liquid form.

Preferably, for a liquid product, and when a gas is used as an oxidizing, reducing or neutral agent, the oxidoreduction potential of said first phase is modified by bubbling of the liquid product constituting said first phase with the oxidizing gas, the reducing gas or the neutral gas.

The second phase is preferably a gas phase, for example a gas phase constituted of the gas upper atmosphere contacting the surface of the first liquid or solid phase.

The oxidoreduction potential modification in the first phase determines the value of the first mass sharing coefficient Ki of each of the organic compounds (i) of interest included therein and thus their retention in the first phase or inversely their transfer, at least partially, from the first phase to the second phase, in particular from the first liquid phase to a second gas phase.

The mass sharing coefficient Ki of an organic compound (i) is defined by the following formula:
Ki=Yi/Xi
wherein:

Xi represents the mass fraction of the organic compound (i) in the first phase; and

Yi represents the mass fraction of the organic compound (i) in the second phase.

Hereinafter, the examples illustrate several embodiments of the above method with aroma-type organic compounds, the first phase being a liquid phase and the second phase being a gas phase.

According to the redox potential value applied to the liquid phase, an aroma retention in the liquid phase, or inversely an aroma release from the liquid phase to the gas phase are respectively observed.

It is for example observed that, for an aroma-type organic compound (i), the 2-nonanone, a modification of the liquid phase redox potential towards a redox potential of a value lower than the initial value, in particular toward a redox potential of negative value, causes a retention of this compound in the liquid phase, whereas a modification of the liquid phase redox potential towards a redox potential of a value higher than the initial value, in particular towards a redox potential of positive value, causes a release of the 2-nonanone compound.

It is to be reminded that the redox potential of a medium corresponds to the average availability of the electrons in this medium. The redox potential of a composition, in particular a composition in a liquid phase form, can be measured by any technique known by a man skilled in the art. The man skilled in the art should be able to use a redox measurement apparatus by using a probe marketed by the Mettler company connected with a measurement device, pH-meter or voltmeter.

The value of the mass sharing coefficient Ki can be measured by any technique known by the man skilled in the art.

Particularly, the value of the mass sharing coefficient Ki of the organic compound (i) can be measured in a static condition as described by BAKKER et al. (1998, Journal of Agricultural and Food Chemistry, vol. 46: 2714-2720 or also by CONNER et al. (1998, Journal of the Science of Food and Agriculture, vol. 77: 121-126).

Sealed flasks containing the liquid phase comprising the organic compound (i) are prepared, the upper volume of the sealed flasks being occupied by a gas phase which is in contact with the liquid phase. Then, the equilibrium point of the exchanges between the liquid phase and the gas phase is obtained by incubation of the sealed flasks under determined temperature and pressure conditions, for example at 1.75 bar, at the temperature of 30° C., during a period of 1 hr 30.

The weight amount of the organic compound (i) respectively present in the gas phase and in the liquid phase is then measured, for example by gas chromatography, which allows to respectively calculate the mass fraction (Xi) of the organic compound (i) in the liquid phase and the mass fraction (Yi) of the organic compound (i) in the vapour phase, the obtained values for Xi and Yi then allowing for the computation of the mass sharing coefficient (Ki) of the organic compound (i) between the two phases.

The measurements of the mass sharing coefficient Ki of the organic compound (i) can also be realized in a static mode for other types of phases, including by extraction for solid/gas and liquid/liquid phases, as described in the examples.

According to the above process, the first and second phase types are respectively chosen from:
a first hydrophilic liquid phase and a second gas phase;
a first hydrophobic liquid phase and a second gas phase;
a first hydrophilic liquid phase and a second hydrophobic liquid phase;
a first hydrophobic liquid phase and a second hydrophilic liquid phase;
a first solid phase and a second gas phase.
In a quite preferred way, the method of the invention is applied to the checking of the value of the mass sharing coefficient Ki of an organic compound (i) or each of the organic compound mixture (i) between a first hydrophilic or hydrophobic liquid phase and a second gas phase.

By “hydrophilic” liquid phase, it is meant according to the invention essentially an aqueous liquid phase in which an organic compound (i) or a plurality of organic compounds (i) is dissolved. Illustrative examples of a hydrophilic liquid phase according to the invention include water containing one or more flavouring organic compounds (i), fruit juices, sodas, and dairy products.

By “hydrophobic” liquid phase, it is meant according to the invention essentially a liquid containing a high proportion of fatty acids, optionally esterified as lipids. Illustrative examples of an hydrophobic liquid phase include in particular plant or animal oils, butter, margarine or mammalian milk cream, in particular cow's, sheep's, donkey's or goat's milk.

A given organic compound (i) is distributed respectively between a first hydrophilic liquid phase and a second hydrophobic liquid phase in the case of a water-in-oil emulsion. Illustrative examples of a water-in-oil emulsion include in particular vinaigrettes and food sauces.

The organic compound (i) is distributed respectively between a first hydrophobic liquid phase and a second hydrophilic liquid phase in the case of oil-in-water emulsions. Illustrative examples of an oil-in-water emulsion include in particular emulsions for food uses such as mayonnaise and vinaigrette sauce.

For all the products to be treated, the use of an organic or mineral compound or a gas, as a respectively oxidizing, reducing or neutral agent, allows for the checking of the intended organic compound retention (i) to be achieved.

However, there is an additional technical advantage provided by the use of an oxidizing, reducing or neutral gas to implement the method according to the invention. This additional advantage lies in the ability for the gas molecules to easily come in contact with the whole first phase, whether this first phase is a liquid phase or a solid phase.

In the case of a liquid phase, the gas which can be put in contact with the liquid phase by bubbling, can thus be put in contact and homogeneously be spread in the whole liquid phase. A portion of the gas going through the liquid phase is retained in the liquid phase by dissolution and thus causes a modification of the liquid phase redox potential.

Due to the good distribution of the gas in the liquid phase and to the dissolution of a portion of the gas in said liquid phase, the oxidoreduction potential value is homogeneous in the whole liquid phase and can be readily held constant over time.

Moreover, a gas can also be used in order to modify the oxidoreduction potential value of a first solid phase, due to the ability of the gas to enter the interstices of a heterogeneous solid phase and thus to come in contact with the largest part of the outer and inner surfaces of the solid phase, as when the solid phase is constituted of a porous food composition, as it is particularly the case for food compositions, including caterer products, prepared dishes, salads, raw vegetables, cooked pork meats, cakes, meat pastries, pasta products (fresh pastes, bread dough, Viennese pastries) or even fruits or vegetables.

Preferably, the oxidizing gas is oxygen or an oxygen-containing gas. Advantageously, an oxygen-containing gas has an oxygen content from 1% in volume to 50% in volume, preferably from 1% in volume to 10% in volume and more preferably from 1% in volume to 5% in volume.

Preferably, the reducing gas is hydrogen or a hydrogen-containing gas. Advantageously, a hydrogen-containing gas has an hydrogen content from 0,1% in volume to 20% in volume, preferably from 1% in volume to 5% in volume and more preferably the hydrogen volume percentage will not exceed 4%.

Preferably, the neutral gas is selected from carbon dioxide, nitrogen, helium or a carbon dioxide-, nitrogen protoxide-, nitrogen- or helium-containing gas, and the mixtures thereof.

The proportion of neutral gas in the gas phase is not determining, because the neutral gas does not modify the starting redox potential. Several neutral gases can be used in mixture, in various proportions, according to the intended application.

Preferably, when an oxidizing agent is an oxidizing organic or mineral compound, it is selected from molecules such as iron, copper, hydrogen peroxide (H₂O₂) and potassium ferricyanide.

Preferably, when the reducing agent is a reducing solid organic or mineral compound, it is selected from molecules of natural or synthetic origin considered as reducing or molecules having anti-oxidizing properties, such as glutathion, cystein, mercaptoethanol, dithiothreitol, ascorbic acid or tocopherol.

The results of the examples illustrate the implementations of the method for checking the retention of an organic compound (i) for a diversity of first liquid phases of distinct compositions and for a plurality of aroma-type organic compounds (i).

Therefore, a checking of the retention of an aroma-type organic compound has been reached for a diversity of first liquid phases, respectively an aqueous solution adjusted to different pH values, an aqueous solution containing a protein and two first complex liquid phases, respectively skimmed milk or whole milk.

The results show that the mass sharing coefficient Ki obtained by lowering the oxidoreduction potential value by contacting the first liquid phase with a gas containing 100% hydrogen illustrate that a negative level of redox potential favours the 2-nonanone retention in the liquid phase.

On the contrary, increasing the redox potential value by contacting the aqueous liquid phase with a gas containing 100% oxygen or a gas containing 21% oxygen, in this case air, illustrates that a redox potential positive value favours the release or the transfer of the 2-nonanone towards the second gas phase. The same results are observed when the first liquid phase is in contact with a gas containing 100% nitrogen, which does not modify the initial redox potential value.

The results also show that increasing the redox potential value by addition, in the aqueous liquid phase, of an oxidizing organic compound, like potassium ferricyanide, favours the 2-nonanone release or transfer towards the second gas phase.

In contrast, the reduction of the redox potential value by addition, in the aqueous liquid phase, of a reducing organic compound, like dithiothreitol (DTT), favours the 2-nonanone retention in the liquid phase.

It is also observed that increasing the pH value of the first liquid phase induces an increase of the given organic compound (i) retention, which was expected because a high pH reduces the oxido-reduction potential value of the solution.

A “high” pH is a pH having a pH value of more than 7. A “low” pH is a pH having a pH value of less than 7.

Advantageously, a low redox potential, according to the invention, is a redox potential, the value of which ranges from −100 mV to −500 mV, preferably from −100 mV to 400 mV and more preferably from −100 mV to −350 mV.

Advantageously, a high redox potential, according to the invention, is a redox potential, the value of which ranges from +100 mV to +900 mV, preferably from +200 mV to +800 mV and more preferably from +200 mV to +700 mV.

A neutral redox potential according to the invention is a redox potential, the value of which ranges from −99 mV to +99 mV.

Generally, using several distinct aroma-type organic compounds, a growth of the mass sharing coefficient Ki value of said organic compound can be observed when the redox potential value is lowered, as for example with the 2-nonanone compound or the allyl isothiocyanate compound (AITC), which is a sulfur compound.

For other organic aroma-type compounds, such as diacetyl, which is a dicetone, or for ethyl hexanoate, which is an ester, a diminution of the first liquid phase redox potential induces respectively:

for diacetyl, an increase of the mass sharing coefficient Ki (release of the diacetyl in the second gas phase), and

for ethyl hexanoate, a lack of significant modification of the mass sharing coefficient value Ki.

When the first liquid phase constitutes a complex medium such as skimmed milk, and using 2-nonanone, it is observed, at a pH of 4.6, a reduction of the mass sharing coefficient value Ki at low redox potential, which corresponds to a retention effect of the 2-nonanone in the first liquid phase constituted by the skimmed milk.

These results confirm the interest of using the method for checking the mass sharing coefficient value Ki of an organic compound (i) or of a plurality or a mixture of organic compounds (i) as defined thereafter to preserve the organoleptic qualities and the flavouring properties or the flavour of the food compositions. In particular, the method according to the invention can be implemented to modify the volatility of various aroma compounds contained in the liquid or solid food compositions.

In particular, the method of the invention can constitutes a particular step in the transformation of base food processing products for which a lack of aroma is observed and leads to denaturation of the product taste or flavour. The method according to the invention is particularly applicable as a particular step in methods of transformation of base food processing products also implying steps of baking, heating, mixing, preservation at room temperature (20° C.-25° C.) or high temperature (>30° C.) or even of chemical modification of the food, including by acidification, salt addition, etc.

The method according to the invention is found to be particularly useful in the manufacturing of low-fat or formulated products having less or no fat content and wherein, by definition, the fat content cannot play its role of aroma retainer any more.

In particular, the implementation of the method according to the invention for manufacturing products with less or no fat content is likely to enhance the aroma retention already achieved by the various protein or polysaccharide additions present in such compositions.

The method according to the invention is also highly useful and is readily realized in the food composition manufacturing methods including a step of introducing a gas into the product being prepared, as for example in the sorbet, fizzy drink, or ice cream manufacturing.

As it will be understood based on the description of the above method of the invention, said method allows to check simultaneously the retention degree, and thus the value of the mass sharing coefficient Ki1, Ki2, . . . , and Kin respectively of each one of the organic compounds (i1), (i2), . . . (in) contained in the first liquid or solid phase, in particular of a liquid or solid food composition,

In order to preserve the organoleptic or flavouring properties of liquid or solid food compositions which are imparted by the complex qualitative and quantitative association of aromas contained therein.

In particular, the method according to the invention is characterized in that the organic compound (i) is an aroma, and preferably an aroma selected amongst 2-nonanone, diacetyl, allyl isothiocyanate, oct-1-en-3-ol, ethyl hexanoate, benzaldehyde, hexanal, carveol, citral, limonene, α-pinene, β-pinene or a mixture thereof.

Another object of the invention is to provide a method for preserving the flavouring properties of a food composition, characterized in that it comprises a step (i) of modifying the oxidoreduction potential of said food composition by addition of an oxidizing agent, a reducing agent or a neutral agent.

As previously indicated, the final value of the oxidoreduction potential is determined in advance by the man skilled in the art, based on the retention degree of the aroma or of the plurality of aromas being desired, said retention degree of each aroma having itself been pre-established by the measurement of the mass sharing coefficient of each aroma, for a series of redox potential values.

As previously defined, the agent used can be a gas or an organic or mineral solid compound.

The food compositions, the aromatic properties of which are preserved thanks to the methods of the invention are quite various. They not only include the different food compositions listed above, such as mineral waters, fruit juices, sodas, baker pastes, sorbets or ice creams, but also food compositions as dairy products (empresured flavoured milks, mousse, cream dessert).

For example, for the treatment of a liquid or semi-liquid food composition by the method of the invention, as an aromatised mineral water, a soda, a dairy composition, a fruit juice, a sorbet or an ice cream, a step of the manufacturing process prior to the final packaging (in bottles, in cartons, etc.) will comprise contacting the liquid composition with a gas, preferably a reducing gas as hydrogen or a hydrogen-containing gas, preferably by bubbling gas into the liquid composition, for example during a period from 5 seconds to 10 minutes, advantageously from 10 seconds to 5 minutes and preferably from 30 seconds to 2 minutes, in order to bring the solution redox potential up to a value such that the respective mass sharing coefficients Ki1, ki2, . . . , Kin of each one of the aromatic organic compounds (i1), (i2), . . . , (in) contained in said liquid food composition tend to a value for which, overall, said organic compounds (i1), (i2), . . . , (in) are predominantly retained in the liquid phase, before their conditioning in a air tight food packaging.

Advantageously, the redox potential of the liquid food composition processed according to the method of the invention is a low redox potential comprised between −100 mV and −500 mV.

Also, the method according to the invention can be implemented as a particular step of the method of manufacturing a solid food composition such as slaughter products (meat, including minced meat, cooked pork meats), fish products (fish, seafood) or bread or pastry products (bread, cakes), in particular any solid food product packaged in a final air tight packaging. Such a step constituted by the method of the invention will comprise contacting the solid food composition with a gas, preferably a reducing gas such as hydrogen or a hydrogen-containing gas, so that the gas does not contact a surface as large as possible of said solid composition, in order to bring the solution redox potential to a value so that the respective mass sharing coefficients Ki1, ki2, . . . , Kin of each one of the aromatic organic compounds (i1), (i2), . . . , (in) contained in said solid food composition tend to a value for which, overall, said organic compounds (i1), (i2), . . . , (in) are predominantly retained in the solid phase, before their conditioning in an air tight food packaging. For example, the gas can be introduced into a refrigerated room in which are stored food compositions to be processed or even the gas can be directly introduced in the packaging constituting the final conditioning of the product, for example a cover, a small container, a pocket or a film, being optionally heatsealable currently commercially available, for example of the type presenting a permeability of less than 100 cc oxygen/m²/24 h, preferably of less than 10 cc oxygen/m²/24 h. The gas, preferably the reducing gas, can be introduced into the packaging of the solid food product(s), for example according to the classical methods of conditioning under modified atmosphere like the “vacuum and gas” method, by putting under vacuum the conditionned food composition followed by the gas injection, which allows for a “gas upper atmosphere” to be located above the solid product. Advantageously, the “gas upper atmosphere” volume is such that it permits to maintain the conditioned product in contact with a sufficient amount of gas, preferably a reducing gas, so as to hold substantially constant the composition redox potential, and thus the respective mass sharing coefficients Ki1, Ki2, . . . , Kin of the aromatic organic compounds (i1), (i2), . . . , (in) contained in the solid food composition, in order to preserve the organoleptic qualities of the thus conditioned solid products at least until the best before date.

Moreover, as already mentioned, the method for checking the retention degree, and thus the value of the mass sharing coefficient Ki of an organic compound (i) or of a plurality or a mixture of organic compounds (i) is also applicable in methods where a selective transfer of one or more organic compounds is intended from a first phase towards a second phase, for example from a first liquid phase towards a second liquid or gas phase, such as the various molecule extraction methods that are commonly implemented, including in the scope of liquid effluent decontamination methods.

In particular, the method for checking according to the invention can be advantageously implemented in cold extraction methods, for example extraction methods using hexane or decane as an extraction solvent. The contacting of a first aqueous liquid phase containing the compound(s) to be extracted with the oxidizing agent, the reducing agent or the neutral agent will allow to check the mass sharing coefficient Ki of the compound(s) to be extracted, enhancing their transfer from the first aqueous liquid phase towards the second liquid phase constituted by the extraction solvent, for example hexane or decane.

Therefore, another object of the invention consists in the application of the method for checking the value of the mass sharing coefficient Ki of an organic compound (i) to the extraction of the organic compounds contained in a starting product.

The present invention is further illustrated, without being limited, by the following figures and examples.

### FIGURES

FIG. 1 illustrates the value of the mass sharing coefficient Ki, visualized in ordinate in the figure by the integrated surface value of the signal peak obtained with the head measurement (head-space). In the abscissa are represented the redox potential values expressed in millivolts. The tested organic compound is the 2-nonanone, respectively at pH 2 (full diamond) and at pH 7.5 (full square).

FIG. 2 illustrates the results obtained with the 2-nonane in an aqueous solution containing 3% β-lactoglobuline by weight of the solution, respectively at pH 2 (full triangle) and at pH 7.5 (full circle). In the ordinate, the integrated surface of the head peak (head-space) is expressed in thousands. In the abscissa, the redox potential value of the aqueous solution is expressed in millivolts.

FIG. 3 illustrates the results obtained with the allyl isothiocyanate in an aqueous solution at a pH 2 (full diamond) and at pH 7.5 (full square) or in an aqueous solution containing 3 wt % of β-lactoglobuline, respectively at pH 2 (full triangle) and at pH 7.5 (full circle). In the ordinate, the integrated surface of the head peak (head-space) is expressed in thousands). In the abscissa, the redox potential value is expressed in millivolts.

FIGS. 4 and 5 illustrate the results respectively obtained with diacetyl and ethyl hexanoate in the same operating conditions as in FIG. 3 for allyl isothiocyanate.

FIG. 6 illustrate the results obtained with the 2-nonanone, respectively in water at pH 7.5 (black square) or at pH 7 (empty square) or also in water containing 3 wt % of β-lactoglobuline respectively at pH 7.5 (full circle) and at pH 7 (empty circle).

FIG. 7 illustrates the results obtained with the 2-nonanone in a first liquid phase consisting in skimmed milk respectively at pH 6.7 (full diamond) or at pH 4.6 (full triangle) or also with whole milk respectively at pH 6.8 (empty square) or with whole milk (full square).

FIG. 8 illustrates the results of a redox potential measurement of an aqueous solution of 2-nonanone in a static condition (“headspace” measurement) with non pressurized flasks (diamonds) or pressurized flasks with hydrogen (squares).

FIG. 9 illustrates the results of a measurement of the retention degree of 2-nonanone between an aqueous phase (water) and an organic liquid phase (dichloromethane) with non pressurized flasks (diamonds) or pressurized flasks with hydrogen (squares).

FIG. 10 illustrates the results of a measurement of the retention degree of the 2-nonanone in an aqueous phase (water) (i) in the presence of a reducing organic compound, dithiothreitol (DTT), and (ii) in the presence of an oxidizing mineral compound, potassium ferricyanide. FIG. 10 also presents the comparative results obtained with hydrogen (H₂) and helium (He).

### EXAMPLES

### A. Materials and Methods of Examples 1 to 11

The study of the checking of the mass sharing coefficient Ki of an organic compound (i) between two phases, respectively a first liquid phase and a second vapour phase, as a function of the redox potential value includes the quantification of the organic compound (i) in the vapour phase at equilibrium, by the static headspace technique. In the examples, the method of the invention is illustrated with aroma-type organic compounds (i).

The static headspace technique consists in analyzing the vapours in equilibrium above a solution placed in a confined atmosphere at a given temperature. The vapour analysis in gas chromatography (CPG) gives the volatile compound concentration of the “head space”.

1. Preparation of the Solutions

The aroma purity has been achieved by gas chromatography (CPG) and evaluated at 95% or more.

Different aromas of different chemical classes have been tested: namely 2-nonanone, diacetyl, allyl isothiocyanate, oct-1-en-3-ol, ethyl hexanoate, benzaldehyde, hexenal, carveol, and a mixture of citral, limonene, α-pinene, and β-pinene.

The aroma solutions are prepared in a solution of 50 mM NaCl, the pH of which has been adjusted to pH 3 with HCl (1N) or at pH 7.5 with NaOH (1N).

Furthermore, tests have also been realized in the presence of a lactoserum protein, the β-lactoglobuline, dispersed (3%) in a solution of 50 mM NaCl at pH 3 or pH 7.5, or in whole or skimmed milk.

The different solutions (100 mL) are placed within Schott flasks of 250 mL.

2. Modification of the Redox

The redox is modified by bubbling a gas (hydrogen, nitrogen, helium, or oxygen) at a flowrate of 20 mL.min⁻¹ for a previously determined time (8 min). The redox measurement is realized after the gas bubbling step with a redox measurement electrode connected to a pH meter-voltameter. The thus prepared solutions are distributed on the basis of 10 mL in brown flasks of 40 mL (Supelco, France) closed by Mininert valve plugs (Supelco). The different flasks are pressurized with gas that has served to mofify the redox during 1 min 20 with a flowrate of 260 mL.min⁻¹.

A control is realized in the presence of air: the bubbling step is not realized, only the pressurization occurs, in the same conditions as the other gasses.

The flasks are then equilibrated in a water bath at 30° C. for 1 hr 30. At least 3 brown flasks are prepared for each gas, a flask serving only for one injection.

3. Analysis of the Vapour Phase

At the equilibrium, 1 mL of vapour phase is taken with a 1 mL gas syringe (SGE), then injected in a gas chromatograph (CPG) provided with a DB-WAX column (J&W Scientific, diameter 0.32 mm, length 30 m, phase thickness 0.5 μm) and a flame ionization detector. The injector and detector temperatures are respectively 250° C. and 260° C. The vector gas velocity (hydrogen) at 143° C. is of 37 cm.sec-¹. The signal acquisition is achieved with a chromatogram acquisition and treatment software developed in the laboratory.

Thus, the amount of aroma present in the vapour phase is determined for each gas.

4. Evaluation of the Losses During the Bubbling

The aroma losses upon bubbling have been evaluated by entrapment on an absorbing polymer (Tenax) of the gas effluent at the flask outlet and by extraction of the liquid phase with pentane. The same is done for all the gasses being used.

The loss test is made on a 50 mL of a 2-nonanone solution (50 ppm) in NaCl (50 mM, pH 7.5).

The gas is simultaneously bubbled (8 min) at the same flowrate of 20 mL.min⁻¹ in the flask, then the gas effluent is entrapped on Tenax at the flask outlet. This Tenax trap is afterwards desorbed on a TCT Chrompak apparatus coupled with a HP chromatograph provided with a FID detector.

The amount of aroma entrapped on Tenax is determined in comparison with an external calibration curve. This calibration curve is obtained as described hereinafter: 1 μl of 2-nonanone solution is deposited in pentane in the glass cotton of the Tenax tube upper part, then the Tenax tube is desorbed in the same conditions as for the analysis. Different concentrations have been tested.

The amount of aroma remaining in the liquid phase is determined by extraction of the aroma solution (5 mL) by pentane (5 mL). One μl of the organic phase is injected in split/splitless in CPG. A comparison is made with an external calibration, obtained by injection of 1 μl of 2-nonanone solution in pentane.

5. Study of the Aroma Stability with Time Versus Redox

The aroma stability with time (2 months) versus redox is studied for different aromas alone in solution in 50 mM NaCl, pH 7.5, and in admixture (limonene, citral, α-pinene, β-pinene) in a citrate/citric acid buffer at 55 mM, pH 3.44, to be close to a true product, orange juice. The protocol used to modify the redox is identical to that described in paragraph 2. However, the solutions and all the material used are sterilized in the autoclave (20 mn at 121° C.). Moreover, the used gases (H₂, N₂, air) for bubbling and pressurization are passed onto a sterile filter of 0.2 μm.

For each time and each gas, 3 flasks are prepared.

At the given time, the flasks are equilibrated for 1.30 h in a water bath at 30° C., then 1 mL of vapour phase is taken and injected in CPG (cf. paragraph 3). The redox is then measured. The liquid phase of the flasks corresponding to the same gas is pooled and extracted twice with dichloromethane (3 mL). The organic phase (extract) is dried on sodium sulfate. One μL of extract is then injected in CPG, so as to determine the amount of aroma present in the liquid phase.

6. Pressure Measurement within the Flasks

The pressure within the flasks is measured with a Digitron electronic pressure sensor, model 2000-83.

The protocol used is the following one.

For hydrogen and nitrogen, the gas (hydrogen or nitrogen) is bubbled in 150 ml of milli-Q water during 8 min at a flowrate of 20 ml.min⁻¹. 10 ml of the thus conditioned Milli-Q water are distributed in 10 brown flasks and the flasks are closed by Mininert valves. The flasks are then pressurized with the corresponding gas (hydrogen, nitrogen, air) during 1 min 20 with a flowrate of 260 ml.min⁻¹.

The thus prepared flasks are left during 1 h at room temperature.

The pressure measurement is then realized by sticking a needle in the Mininert valve septum. This needle is connected to the pressure sensor with a tube. The reading of the pressure is directly done on the sensor. This pressure is expressed in mbar.

### B. Results

### Example 1

Study of the Aroma Losses During Bubbling

Regardless of the gas employed, the losses are low (<3%). It is to be noticed that:
for hydrogen, the losses are 0.3%,
for nitrogen, the losses are 2%,
for helium, the losses are 0.5%,
for oxygen, the losses are 2.3%.

The very low aroma losses observed show that such losses do not depend on the redox potential value. As a result, contacting the liquid phase to be treated with the gas, by bubbling, does not cause a significant loss of organic aroma-type compounds (i).

### Example 2

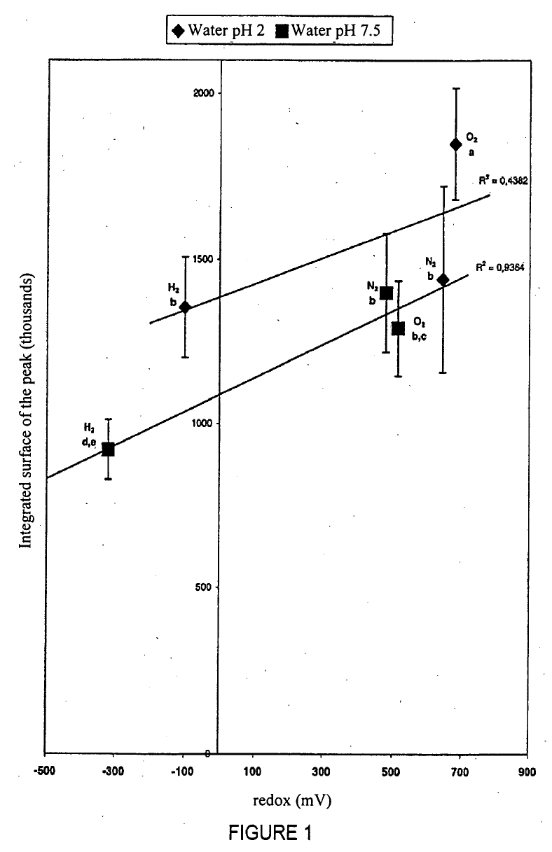

During a precise period of time in an aqueous solution adjusted at pH 7.5 and containing an aroma, 2-nonanone, different gasses are bubbled for modulating the medium redox: nitrogen, hydrogen and oxygen. It has been verified that bubbling does not modify the aroma concentration of the aqueous solution before the headspace measurements. In the presence of nitrogen and oxygen, the medium redox is adjusted at approximately +500 mV, whereas, in presence of hydrogen, the redox is adjusted at −320 mV. The experiments are repeated 3 times. The results (FIG. 1) show, after headspace measurement, a modification of the medium aroma release of the order of −30% at low redox.

### Example 3

The experiment of Example 2 is realized, but in an acid medium: the results (FIG. 1) show a modification of the aroma release at low redox of −20%.

### Example 4

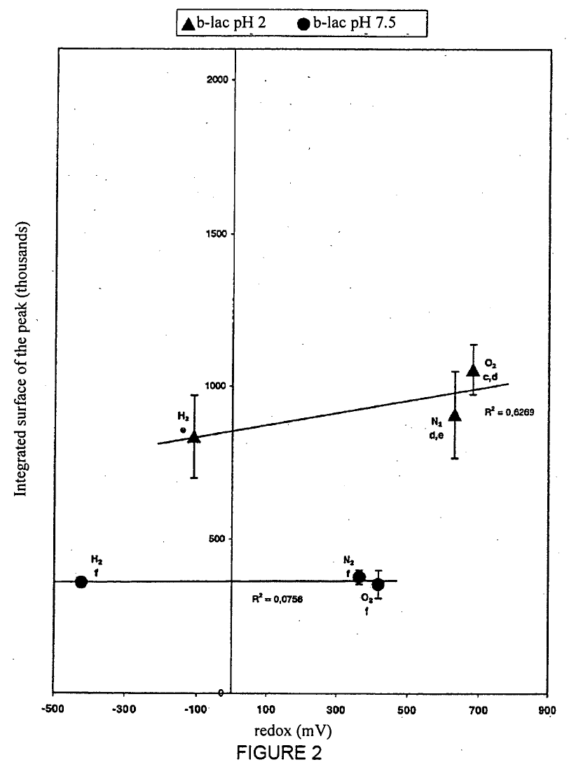

The experiments of Examples 2 and 3 are realized in presence of a protein in the aqueous solution, the β-lactoglobuline at 3%: the results does not show any difference of retention depending on the redox (FIG. 2).

### Example 5

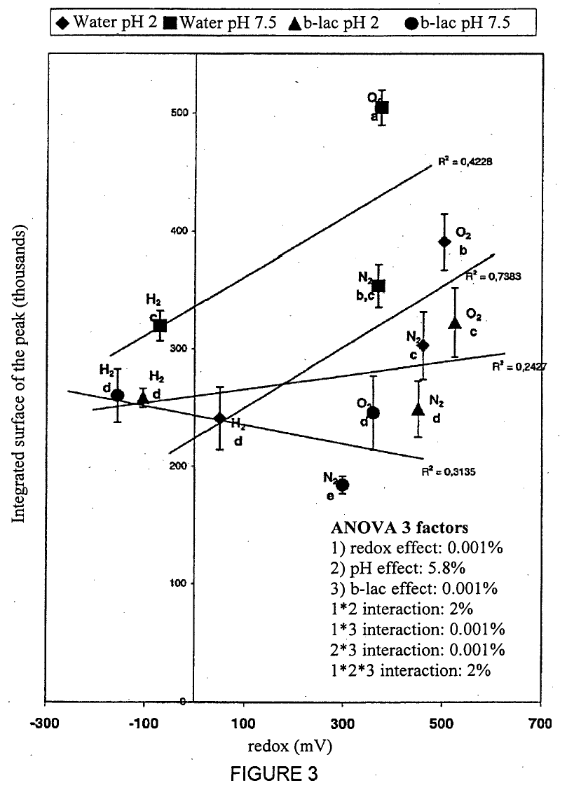

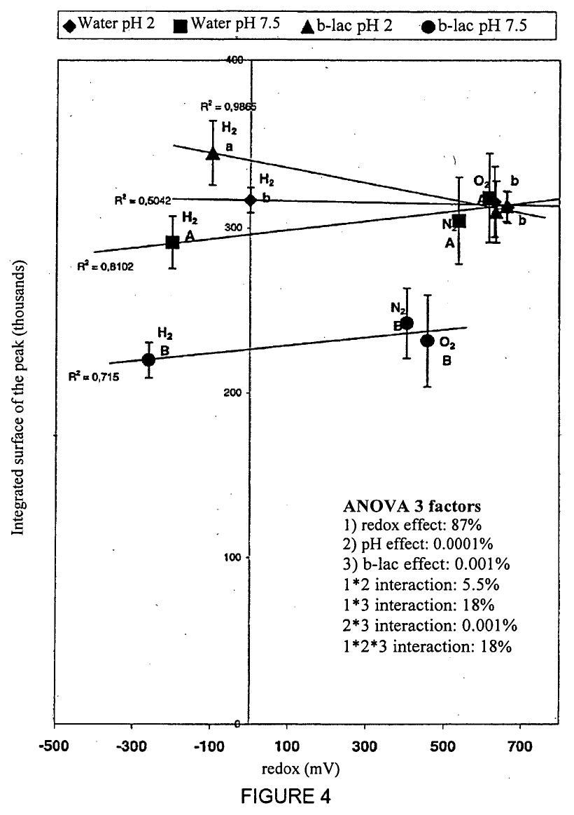

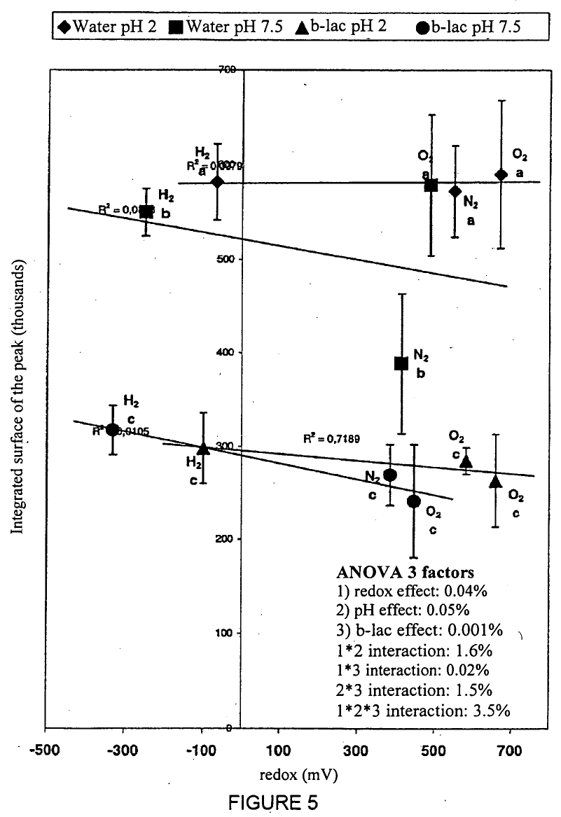

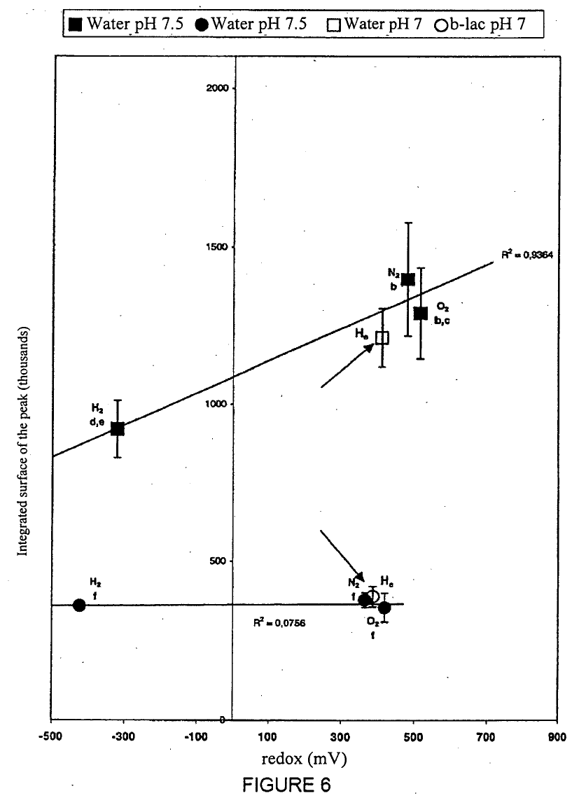

The experiments of Examples 2, 3, 4 are realized with different aroma molecules: AITC (sulfur compound), diacetyl (dicetone), ethyl hexanoate (ester). The results (FIG. 3, 4, 5) show an exhaustive effect on the diacetyl (+20%) and a retention effect on the AITC (−30%). There is no effect on the ester.

### Example 6

The experiment of Example 2 is realized with helium gas (close to hydrogen). The redox is adjusted at +400 mV. There is no significant difference in the retention results of the 2-nonanone within the liquid phase, compared to the observed results.

### Example 7

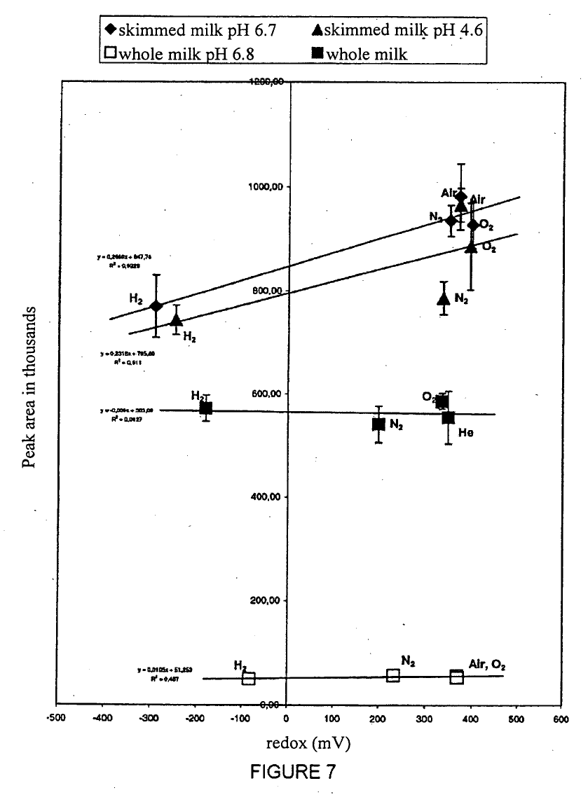

The experiment of Example 2 is realized in skimmed milk. The results (FIG. 7) show a retention effect at low redox (−20%) and no effect at high redox.

### Example 8

The experiment of Example 2 is realized with whole milk. The results (FIG. 7) do not show any redox effect on the aroma release.

### Example 9

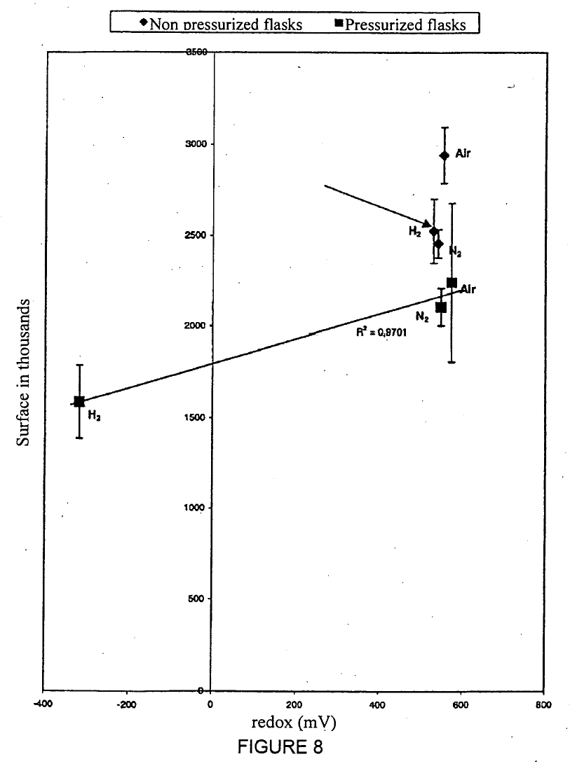

The experiment of Example 2 is realized, but while maintaining or not the flask atmosphere of the flask in the redox conditions identical to the liquid phase ones. The results of FIG. 8 show a retention effect at low redox and under reducing atmosphere (hydrogen—pressurized flask). The effect inverses when the atmosphere is neutral or oxidizing and the redox increases (arrow—hydrogen non pressurized flask).

### Example 10

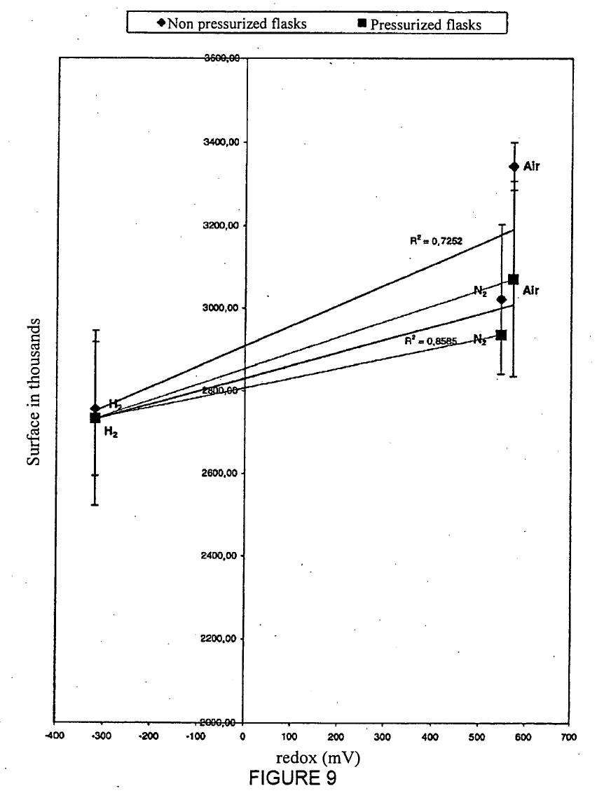

The experiment of Example 2 is realized, but in a mixture of water (aqueous phase)/dichloromethane (CH₂Cl₂, organic phase). The results of FIG. 9 show that, at low redox, the 2-nonanone is better retained in the aqueous phase and is thus less extracted by the organic phase.

### Example 11

1. Preparation of the Reducing Medium

The reducing medium is obtained by addition of DTT(1,4-dithiothreitol). The ultrapure water employed for the solution preparation is degassed with a high gas flowrate during 1 h. La 2-nonanone solution (50 ppm) is prepared through addition of such aroma into the degassed water; the solution volume has been chosen so that a minimum of air exists between the plug and the solution. The thus prepared solution is stirred for homogenisation for 30 min.

An aliquot of this solution is added with DTT (10 g.l⁻¹) and then this solution is stirred for 30 min.

In order to prevent the dilution phenomenon, another protocol has been used: the degassed water is added with DTT (10 g.l⁻¹), then the aroma is added.

The thus prepared solutions are distributed at a level of 10 mL in 40 mL brown flasks (Supelco, France) closed by Mininert valves (Supelco). The flasks are pressurized with nitrogen for 1 min with a flowrate of 260 mL.min⁻¹. The overpressure is then evacuated. The flasks are then equilibrated during 1 h 30 in a water bath at 30° C. For each one of the conditions, 4 repetitions are realized.

2. Preparation of the Oxidizing Medium

The oxidizing medium is obtained by addition of potassium ferricyanide.

Two aroma solutions are prepared: for solution 1, the 2-nonanone is solubilized in water and then the solution is stirred for 30 min; for solution 2, the potassium ferricyanide is dissolved in water, then the 2-nonanone is added. This solution is afterwards stirred during 30 min.

The thus prepared solutions are distributed at a level of 10 mL in 40 mL brown flasks (Supelco, France) closed by Mininert valves (Supelco).

The flasks are then equilibrated during 1 h 30 in a water bath at 30° C. For each one of the conditions, 4 repetitions are realized.

Results

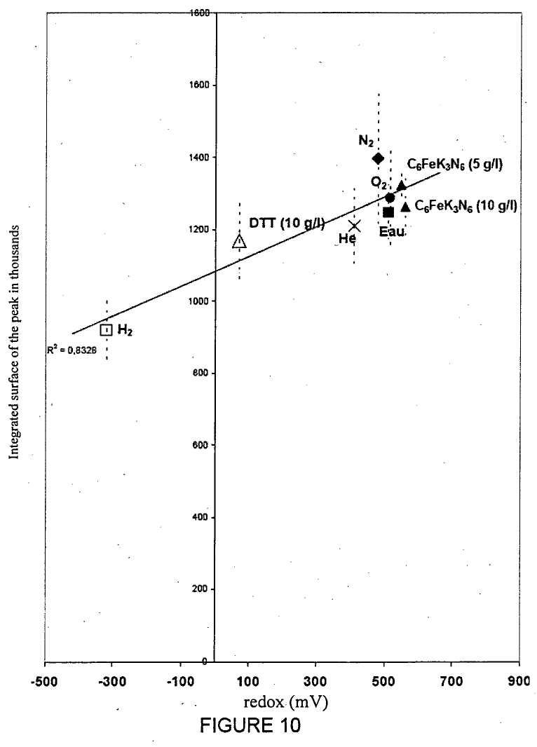

The experiment of redox modification is realized by addition of molecules. The results are presented in FIG. 10.

FIG. 10 shows that the results obtained with the molecules are similar to the results obtained with the gasses, i.e. that in a reducing medium, there is less 2-nonanone released in the vapour phase than in the oxidizing medium.

1. Method for checking the retention of an organic compound (i) or a plurality of organic compounds (i) within a liquid or solid phase, characterized in that it comprises a step in which the oxidoreduction potential of said solid or liquid phase is modified by contacting said solid or liquid phase with an oxidizing agent, a reducing agent or a neutral agent, the oxidoreduction potential value of said solid or liquid phase determining the retention degree of the organic compound (i) or each of the organic compounds (i) within said liquid or solid phase.

2. Method according to claim 1, wherein the liquid or solid phase constitutes a first phase having at least one common contact surface with a second phase, the second phase being a gas phase or a liquid phase, said method being characterized in that the oxidoreduction potential value of said first liquid or solid phase determines the value of the mass sharing coefficient (Ki) of the organic compound (i) or each of the organic compounds (i) between said first phase and said second phase.

3. Method according to claim 1, characterized in that the first and second phase types are respectively selected amongst:
a first hydrophilic liquid phase and a second gas phase;
a first hydrophobic liquid phase and a second gas phase;
a first hydrophilic liquid phase and a second hydrophobic liquid phase;
a first hydrophobic liquid phase and a second hydrophilic liquid phase; and
a first solid phase and a second gas phase.

4. Method according to claim 1, characterized in that the oxidizing agent, the reducing agent or the neutral agent is respectively an oxidizing gas, a reducing gas or a neutral gas.

5. Method according to claim 4, characterized in that the oxidizing gas is oxygen or an oxygen-containing gas.

6. Method according to claim 4, characterized in that the reducing gas is hydrogen or a hydrogen-containing gas.

7. Method according to claim 4, characterized in that the neutral gas is carbon dioxide, nitrogen, helium, nitrogen protoxide or a gas containing carbon dioxide, helium or nitrogen protoxide, and the mixtures thereof.

8. Method according to claim 1, characterized in that the oxidizing agent, the reducing agent or the neutral agent is a respectively an oxidizing or reducing organic or mineral solid compound.

9. Method according to claim 8, characterized in that the oxidizing solid compound is selected amongst molecules such as iron, copper, hydrogen peroxide or potassium ferricyanide.

10. Method according to claim 8, characterized in that the reducing solid compound is selected amongst reducing or anti-oxidizing molecules of natural or synthetic origin such as glutathion, cystein, mercaptoethanol, dithiothreitol, ascorbic acid and tocopherol.

11. Method according to claim 1, characterized in that the organic compound (i) is an aroma.

12. Method according to claim 11, characterized in that the aroma is selected amongst 2-nonanone, diacetyl, allyl isothiocyanate, oct-1-en-3-ol, ethyl hexanoate, benzaldehyde, hexanal, carveol, citral, limonene, α-pinene, β-pinene or a mixture thereof.

13. Application of the method according to claim 1 to the preservation of the aromatic properties of a food composition.

14. Application according to claim 13, characterized in that the food composition is a solid food composition.

15. Application according to claim 13, characterized in that the food composition is a liquid food composition.

16. Method for preserving the aromatic properties of a food composition, characterized in that it comprises a step (i) of modifying the oxidoreduction potential of said food composition by addition of an oxidizing agent, a reducing agent or a neutral agent.

17. Application of the method according to claim 1 to the extraction of organic compounds contained in a starting product.
